(19) United States
(12) Patent Application Publication
(10) Pub. No.: US 2020/0302701 A1
(43) Pub. Date: Sep. 24, 2020

(54) TERMINAL DEVICE, SERVER DEVICE, AND COMPUTER PROGRAM FOR RECORDING STATES OF WORK AS IMAGE

(71) Applicant: KOBAYASHI MANUFACTURE CO., LTD., Ishikawa (JP)

(72) Inventor: Yasunori KOBAYASHI, Ishikawa (JP)

(21) Appl. No.: 16/896,228

(22) Filed: Jun. 9, 2020

Related U.S. Application Data
(62) Division of application No. 15/555,547, filed on Sep. 4, 2017.

(51) Int. Cl. G07C 1/10; G06F 13/00; G06Q 50/08; G06Q 10/10; G05B 19/4155; G06Q 10/06

(52) U.S. Cl. CPC G07C 1/10; G06F 13/00; G06Q 50/08; G06Q 10/10; G05B 2219/37574; G06Q 10/06; G05B 2219/37078; G05B 2219/37208; G05B 19/4155

(57) ABSTRACT

A means capable of accumulating images representing captured states of work without requiring cumbersome input operations to be made by a worker is provided. Terminal device is a mobile communication terminal device incorporating a camera and can communicate data with server device via mobile phone network and Internet. A worker who performs work accesses server device using terminal device and causes terminal device to display a list of tasks of the worker. When the worker who has selected a work detail item from the list performs the recording start operation, terminal device sequentially transmits image data captured at predetermined time intervals by the camera to server device. The image data are stored in server device in association with data for identifying work details to be recorded. The manager accesses server device using terminal device and can confirm states of work performed in the past by viewing images of the work.

### TECHNICAL FIELD

The present invention relates to a technique for recording states of work using images.

### BACKGROUND ART

A system for confirming states of past work has been proposed. In the system, images of work details are stored, and a required image is read out and displayed. For example, Patent Document 1, which relates to a patent application by the applicant of the present application, discloses a system for accumulating images captured by imaging devices installed at a work area. In the system, if a user selects a progress display area from among plural progress display areas displayed by the display device, the display device displays an image corresponding to the specified progress display area.

### PRIOR ART DOCUMENT

### Patent Document

Patent Document 1: JP 5416322B

### SUMMARY

### Problem to be solved

The present invention enables accumulation of image data representing captured states of work without requiring cumbersome input operations to be made by a worker.

### Solution

A terminal device according to an embodiment of the present invention comprises: a transmission unit that transmits, to a server device, search condition data indicating a search condition for searching for work details; a receiving unit that receives a work detail data indicating a work detail transmitted from the server device as a response to the transmission of the search condition data; a display instructing unit that causes a display device to display the work detail indicated by the work detail data; an instruction obtaining unit that obtains start instruction data indicating an instruction to start recording and end instruction data indicating an instruction to end recording; and an image obtaining unit that obtains image data generated by an imaging device, wherein the transmission unit transmits, to the server device, the image data generated by the imaging device during a period from a timing according to the start instruction indicated by the start instruction data to a timing according to an end instruction indicated by the end instruction data.

In a preferred embodiment, the terminal device further comprises a work identification obtaining unit that obtains work identification data identifying an item of work detail data selected by a user from among a plurality of items of work detail data in a case that the receiving unit receives the plurality of work detail data as one or more responses to the transmission of the search condition data, wherein the transmission unit transmits the work identification data to the server device.

According to a preferred embodiment, the terminal device further comprises a measurement result obtaining unit that obtains measurement result data generated by a measuring device that measures physical quantity related to work, wherein the transmission unit transmits, to the server device, the measurement result data generated by the measuring device during the period.

According to a preferred embodiment, the transmission unit transmits, to the server device, working time data indicating working time corresponding to the work detail data specified on the basis of the start instruction data and the end instruction data.

According to a preferred embodiment, the image obtaining unit obtains image data indicating a still image generated by the imaging device at a timing when a predetermined condition is satisfied, and the transmission unit transmits to the server device a plurality of items of image data generated by the imaging device during the period, each image data representing a still image.

According to a preferred embodiment, the receiving unit receives capture timing condition data indicating a condition relating to capture timing according to the work detail data from the server device, and the image obtaining unit obtains image data indicating a still image generated by the imaging device at a timing when the condition indicated by the capture timing condition data is satisfied.

According to a preferred embodiment, the terminal device is a mobile communication terminal device incorporating the imaging device.

A server device according to an embodiment of the present invention comprises: a receiving unit that receives, from a terminal device, search condition data indicating a search condition for searching for a work detail; a reading unit that reads work detail data indicating a work detail satisfying the search condition indicated by the search condition data from a storage device; a transmission unit that transmits the work detail data to the terminal device, wherein the receiving unit receives image data from the terminal device; and the server device further comprises a storage instruction unit that causes the storage device to store the image data in association with work identification data for identifying the work detail data.

According to a preferred embodiment, in a case that the reading unit reads out, from the storage device, a plurality of items of work detail data, each work detail data indicating a work detail satisfying the search condition, the transmission unit transmits the plurality of work detail data to the terminal device, the receiving unit receives, from the terminal device, work identification data for identifying work detail data selected by a user of the terminal device from among the plurality of work detail data, and the storage instruction unit stores the image data to the storage device in association with the work identification data received by the receiving unit.

According to a preferred embodiment, the receiving unit receives measurement result data indicating a measurement result of a physical quantity relating to work from the terminal device, and the storage instruction unit stores the measurement result data to the storage device in association with the work identification data.

According to a preferred embodiment, the server device further comprises: a working time obtaining unit that obtains working time data indicating a working time corresponding to the work detail data, a work position obtaining unit that obtains work position data indicating a work position corresponding to the work detail data, an event obtaining unit that obtains event data indicating an event which affects work corresponding to the work detail data at a work position indicated by the work position data during a time period indicated by the working time data, and wherein the storage instruction unit stores the event data to the storage device in association with the work identification data.

According to a preferred embodiment, the receiving unit receives, from the terminal device, a plurality of items of image data, each image data representing a still image, and the storage instruction unit stores the plurality of image data to the storage device in association with the work identification data.

According to a preferred embodiment, the reading unit reads, from the storage device, capture timing condition data indicating a condition relating to capture timing according to the work detail data, and the transmission unit transmits the capture timing condition data to the terminal device.

According to a preferred embodiment, the storage instruction unit causes the storage device to create a folder corresponding to the work identification data and to store, in the folder, the plurality of image data received by the receiving unit.

According to a preferred embodiment, the receiving unit receives, from the terminal device, working time data indicating a working time corresponding to the work detail data, the storage instruction unit stores, in the storage device, the working time data in association with the work identification data, the reading unit reads, from the storage device, working time data stored in association with work identification data for identifying a work content with respect to each of a plurality of work details relating to a certain work target, and the server device further comprises a work history generating unit that generates work history data indicating a time length or a time in which each work corresponding to the plurality of work details relating to the certain work target is performed, based on the working time data read by the reading unit.

According to a preferred embodiment, the receiving unit receives working time data indicating a working time corresponding to the work detail data from the terminal device, the storage instruction unit stores the working time data in association with the work identification data in the storage device, the reading unit reads, from the storage device, for each of the same or similar work details relating to a plurality of work objects, working time data stored in association with the work identification data that identifies a work detail relating to the same or a similar work detail, and the server device further comprises a required time generating unit that generates required time data indicating a statistical amount of time required for work corresponding to the same or similar work details based on the working time data read by the reading unit.

A program, according to an embodiment of the present invention, causes a computer to execute a process, the process comprising: transmitting, to a server device, search condition data indicating a search condition for searching a work detail; receiving work detail data indicating a work detail transmitted from the server device as a response to the transmission of the search condition data; causing a display device to display a work detail indicated by the work detail data; obtaining start instruction data indicating an instruction to start recording and end instruction data indicating an instruction to end recording; obtaining image data generated by an imaging device, and transmitting, to the server device, the image data generated by the imaging device in a period from a timing according to the start instruction indicated by the start instruction data to a timing according to an end instruction indicated by the end instruction data.

A program, according to an embodiment of the present invention, causes a computer to execute a process, the process comprising: receiving, from a terminal device, search condition data indicating a search condition for searching for a work detail; reading, from a storage device, work detail data indicating a work detail satisfying the search condition indicated by the search condition data; transmitting the work detail data to the terminal device; receiving image data from the terminal device; and causing the storage device to store the image data in association with work identification data for identifying the work detail data.

### Effects of the Invention

The above terminal device transmits, to a server device, image data representing an image of work captured while work is performed. The above server device stores image data representing the image of work received from the terminal device, in association with the work detail. Therefore, according to the system combining the above terminal device and the server device, the captured images of work are accumulated in the server device in association with the work details.

The above program implements the above terminal device or the above server device on a computer.

### BRIEF DESCRIPTION OF THE DRAWINGS

FIG. 1 is a diagram showing an overall configuration of an image recording system according to one embodiment;

FIG. 2 is a diagram showing a basic configuration of a computer usable as hardware of a terminal device according to one embodiment;

FIG. 3 is a diagram showing a functional configuration of a terminal device according to one embodiment;

FIG. 4 is a diagram showing a basic configuration of a computer usable as hardware of a server device according to one embodiment;

FIG. 5 is a diagram showing a functional configuration of a server device according to one embodiment;

FIG. 6 is a diagram illustrating a configuration of a work management table stored in a server device according to one embodiment;

FIG. 7 is a diagram illustrating a configuration of a worker table stored in a server device according to one embodiment;

FIG. 8 is a diagram illustrating a configuration of a record management table stored in a server device according to one embodiment;

FIG. 9 is a diagram illustrating a storage format of image data, etc. stored in a server device according to one embodiment;

FIG. 10 is a diagram showing a login screen displayed by a terminal device according to one embodiment;

FIG. 11 is a diagram showing a screen for selecting work details displayed by a terminal device according to one embodiment;

FIG. 12 is a diagram showing a screen during recording displayed by a terminal device according to one embodiment;

FIG. 13 is a diagram showing a status confirmation screen displayed by a terminal device according to one embodiment;

FIG. 14 is a diagram showing an image viewing screen displayed by a terminal device according to one embodiment;

FIG. 15 is a diagram illustrating a storage format of image data, etc. stored in a server device according to one modification;

FIG. 16 is a diagram showing an image viewing screen displayed by a terminal device according to one modification;

FIG. 17 is a diagram illustrating a configuration of a work management table stored in a server device according to one modification;

FIG. 18 is a diagram illustrating a configuration of a viewer table stored in a server device according to one modification;

FIG. 19 is a diagram showing a basic configuration of a computer usable as hardware of a terminal device according to one modification;

FIG. 20 is a diagram showing a functional configuration of a terminal device according to one modification; and

FIG. 21 is a diagram illustrating a configuration of a manager table stored in a server device according to one modification.

### EXEMPLARY EMBODIMENTS

### Embodiment

Image recording system 1 according to one embodiment of the present invention will be described below. Image recording system 1 is a system for recording work with an image. In this regard, image recording system 1 also has a function of recording information related to work such as attribute values (temperature, humidity, etc.) of work environment and/or amounts of materials used for the work with the image.

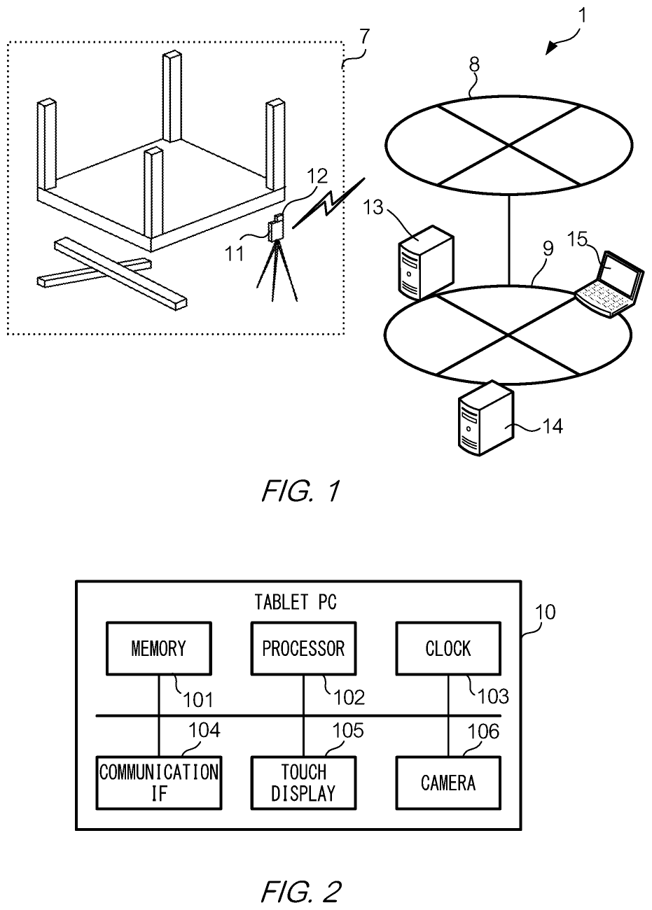

FIG. 1 is a diagram showing an overall configuration of image recording system 1. Image recording system 1 includes terminal device 11, sensor unit 12, server device 13, server device 14, and terminal device 15.

Terminal device 11 is a mobile communication terminal device having a built-in camera (an exemplary imaging device). Terminal device 11 is installed in a work area by a worker and used for capturing an image of work being performed. Terminal device 11 transmits, to server device 13, image data indicating an image captured by the camera and measurement result data indicating a measurement result such as temperature measured by sensor unit 12 (described later.) In FIG. 1, terminal device 11 is connected to Internet 9 via mobile phone network 8. In this regard, it is not necessary for terminal device 11 does not need to go through mobile phone network 8 in data communication with server device 13 but can be connected to Internet 9 directly.

Sensor unit 12 is a measuring device for measuring various physical quantities related to work. Types of physical quantities measured by sensor unit 12 may be temperature, humidity, illuminance, material flow rate, etc. In this regard, the types of the physical quantities are not limited to those listed above. Types of the physical quantities differ depending on a detail of work to be recorded. Therefore, a user connects to terminal device 11 sensor unit 12 whose type corresponds to a work detail before starting the work, and then the user uses sensor unit 12. It is to be noted that sensor unit 12 may be omitted depending on a work detail.

Server device 13 stores image data and measurement result data transmitted from terminal device 11. Upon storing data, server device 13 stores data such as image data in association with work identification data indicating work to which the data relates.

Server device 14 is a server device that stores meteorological data indicating meteorological phenomenon, for example, weather, wind speed, and wind direction, at various positions and time periods. In response to a request, server device 14 distributes the meteorological data at a requested position and time periods to the source device of the request. In a case that a worker performs a certain work (work process), server device 13 obtains from server device 14 meteorological data indicating meteorological phenomenon in a time period and at a work position that is a position where the work is performed, and stores the data in association with work identification data, which identifies the work.

Terminal device 15 is a terminal device used by a manager of the work that is performed, a worker, etc. in order to view images stored in server device 13. In FIG. 1, terminal device 15 is connected to Internet 9 not via mobile phone network 8. In this regard, terminal device 15 may be connected to Internet 9 via mobile phone network 8 in a case where terminal device 15 has a function to connect to mobile phone network 8. Furthermore, terminal device 11 may be used for viewing images while terminal device 11 is not being used for capturing images of a work area. In this case, terminal device 11 is temporarily used as terminal device 15.

Although only one terminal device 11 is shown in FIG. 1, in actuality a plurality of terminal devices 11 exist depending on a number of work areas. It is to be noted that plural terminal devices 11 may be used for capturing images, and so on, in one work area. In addition, although only one terminal device 15 is shown in FIG. 1, in actuality a plurality of terminal devices 15 exist depending on a number of people who browse images stored in server device 13.

Terminal device 11 may have a hardware configuration as a dedicated device designed for image recording system 1, or be a general-purpose computer. A hardware configuration of a computer usable as terminal device 11 is not limited. For example, it may be a laptop PC (personal computer), a tablet PC, and so on. Terminal device 11 may be a tablet PC having a call function (in this example, terminal device 11 is a so-called smartphone). Further, terminal device 11 may be a digital camera incorporating a compact computer equipped with a communication function.

FIG. 2 is a diagram showing a basic configuration of tablet PC 10, which is an example of a computer used as terminal device 11. Tablet PC 10 includes memory 101 that stores various data, processor 102 that performs data processing according to a program stored in memory 101, clock 103 that measures time, communication IF 104 that is an interface that performs data communication, touch display 105 in which a display device (for example, a liquid crystal display) and an operation device (for example, a touch panel) are integrally formed, and camera 106 that captures an image.

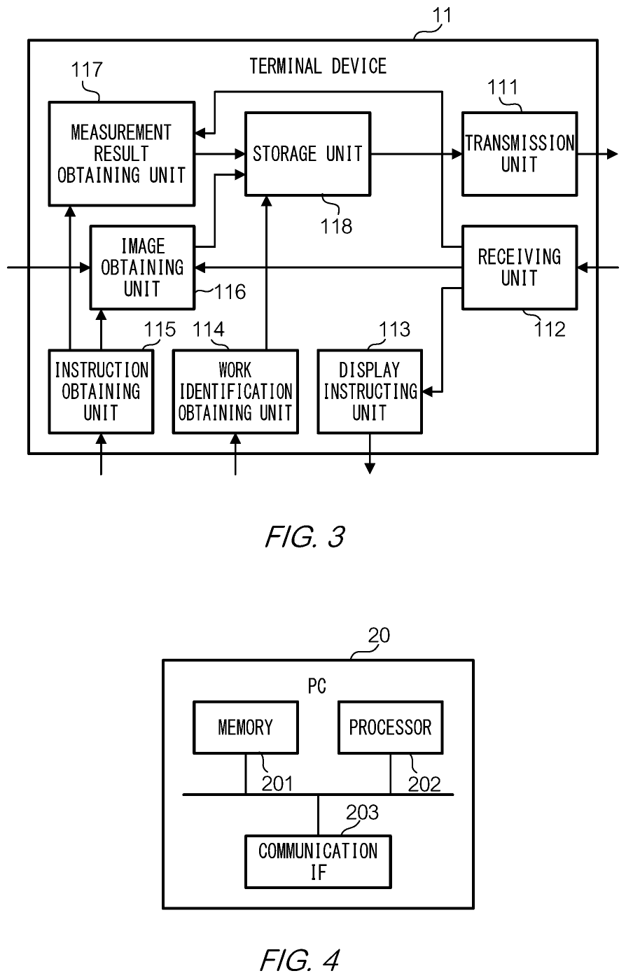

FIG. 3 is a diagram showing a functional configuration of terminal device 11. That is, by tablet PC 10 executing data processing in accordance with a program, functional components of terminal device 11 shown in FIG. 3 are implemented in tablet PC 10. Details of functional components of terminal device 11 will be described below.

Transmission unit 111 transmits various data to server device 13. Data transmitted to server device 13 by transmission unit 111 includes, for example, search condition data indicating a search condition for searching for a work detail to be recorded, work identification data for identifying a work detail selected as a record target by a user from among work details searched in server device 13 according to a search condition, image data indicating an image captured by camera 106, measurement result data indicating a measurement result of a physical quantity such as temperature measured by sensor unit 12, and work time data indicating a time period during which work is to be recorded and specified based on start instruction data and end instruction data (described later) obtained by instruction obtaining unit 115.

Receiving unit 112 receives various data from server device 13. Data received by receiving unit 112 from server device 13 includes, for example, work detail data indicating a work detail transmitted from server device 13 as a response to search condition data transmitted by transmission unit 111, capturing timing condition data indicating a condition relating to capturing timing according to the work detail data, and measurement timing condition data indicating a condition relating to measurement timing according to the work detail data.

Display instructing unit 113 displays a work detail indicated by the work detail data received by receiving unit 112 on a display device (a liquid crystal display, etc.) of touch display 105. Work identification obtaining unit 114 obtains work identification data for identifying an item of work detail data selected by a user from among a plurality of items of work detail data if receiving unit 112 receives the plurality of items of work detail data.

Instruction obtaining unit 115 obtains start instruction data indicating an instruction by a user to start recording and/or end instruction data indicating an instruction by a user to end the recording. Image obtaining unit 116 obtains image data generated by camera 106 (an exemplary imaging device.) It is to be noted that image obtaining unit 116 instructs camera 106 to capture an image at a timing when a condition indicated by the capturing timing condition data received from server device 13 by receiving unit 112 is satisfied. Image obtaining unit 116 obtains image data generated according to the instruction from camera106.

Measurement result obtaining unit 117 obtains measurement result data generated by sensor unit 12 (an exemplary measuring device.) It is to be noted that measurement result obtaining unit 117 instructs sensor unit 12 to measure at a timing when a condition indicated by measuring timing condition data received from server device 13 by receiving unit 112 is satisfied. Measurement result obtaining unit 117 obtains measurement result data generated according to the instruction from sensor unit 12.

Storage unit 118 stores various data. Data stored in storage unit 118 includes, for example, work identification data obtained by work identification obtaining unit 114, image data obtained by image obtaining unit 116, and measurement result data obtained by measurement result obtaining unit 117.

Server device 13 may have a hardware configuration of a dedicated device designed for image recording system 1, or be a general-purpose computer. A hardware configuration of a computer used as server device 13 is not limited. For example, it may be a desktop PC, a laptop PC, and so on.

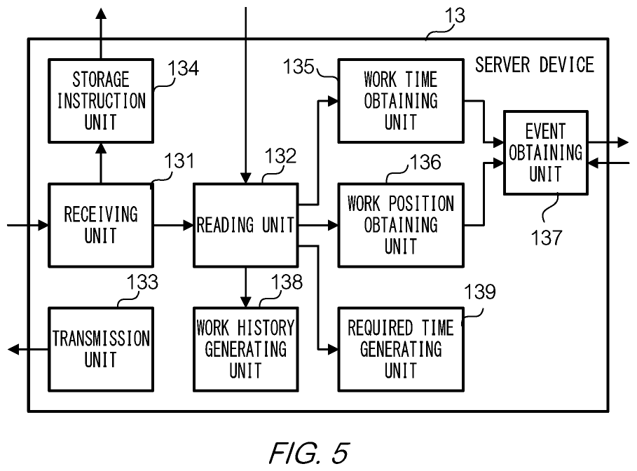

FIG. 4 is a diagram showing a basic configuration of server desktop PC 20, which is an example of a computer usable as hardware of server device 13. Server desktop PC 20 includes memory 201 that stores various data, processor 202 that performs data processing according to programs stored in memory 201, and communication IF 203 that is an interface that performs data communication.

FIG. 5 is a diagram showing a functional configuration of server device 13. That is, by server desktop PC 20 executing data processing in accordance with a program, functional components of server device 13 shown in FIG. 5 are implemented in server desktop PC 20. Details of functional components of server device 13 will be described below.

Receiving unit 131 receives various data from terminal device 11 and terminal device 15. Data received by receiving unit 131 from terminal device 11 includes, for example, search condition data indicating a search condition of work detail, image data generated by camera 106, measurement result data generated by sensor unit 12, work identification data for identifying an item of work detail data selected by a user of terminal device 11, and work time data indicating a time period during which a work detail is to be recorded. Data received by receiving unit 131 from terminal device 15 includes, for example, web page request data for requesting a web page (an image viewing screen) for viewing images, and so on.

Reading unit 132 reads various data from memory 201 (an exemplary storage device.) Data stored in memory 201 will be described below.

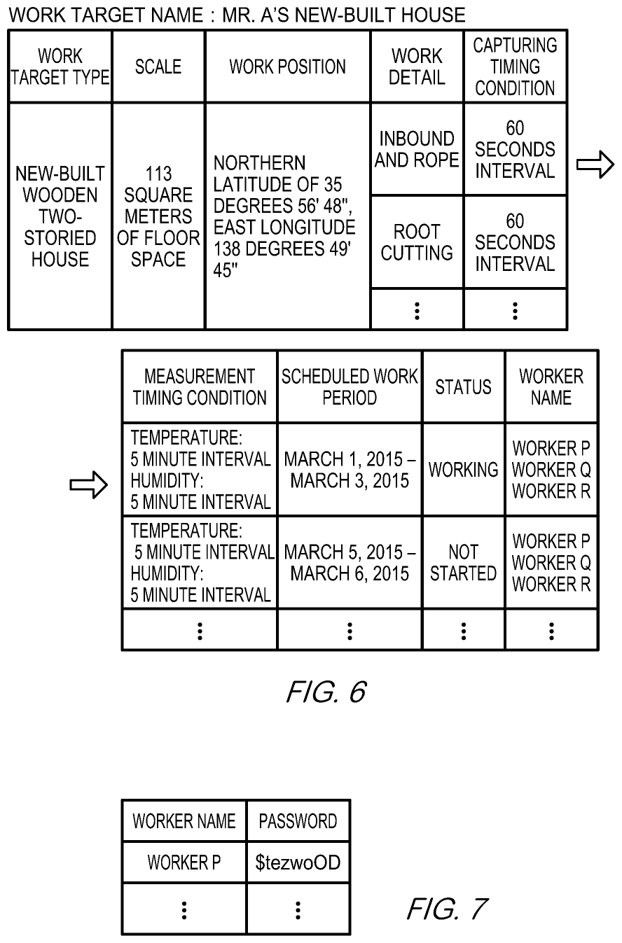

FIG. 6 is a diagram illustrating a configuration of a work management table stored in memory 201. A work management table is prepared for each work target that is to be recorded in image recording system 1. FIG. 6 shows an example of a configuration of a work management table related to a work target identified by a work target name “Mr. A's new-built house.” The work management table includes, for example, data input by a manager, and so on, of work accessed from server device 13 using web browser function of terminal device 15.

The work management table has fields of “work target type,” “scale,” “work position,” “work detail,” “capturing timing condition,” “measurement timing condition,” “scheduled work period,” “status,” and “worker name.” The field “work target type” stores data indicating a type of a work target such as “new-built wooden two-storied house.” The field “scale” stores data indicating a scale of a work target such as “113 square meters of floor space.” The field “work position” stores work position data indicating a position where a work is performed such as, “northern latitude of 35 degrees 56′ 48″, east longitude 138 degrees 49′ 45″.”

The field “work detail” stores work detail data indicating a work detail such as “inbound and rope” and “root cutting.” More than one type of work is often performed on one work target. A plurality of items of work detail data corresponding to a plurality of types of work are stored in the field “work detail.” Fields after the field “capturing timing condition” following the field “work detail” store data corresponding to each work detail data stored in the field “work detail.”

The field “capturing timing condition” stores capturing timing condition data indicating a condition relating to a capturing timing according to a target work detail. A typical condition related to a capturing timing is a condition in which a predetermined time has elapsed, such as “60 seconds interval.” In accordance with this condition, camera 106 captures an image at predetermined time intervals depending on a work detail. Another example of the condition may be “temperature change=1 degree.” In accordance with this condition, each time temperature measured by sensor unit 12 changes by 1 degree, camera 106 captures an image.

The field “measurement timing condition” stores measurement timing condition data indicating a condition related to a measurement timing of a physical quantity relating to a work detail of an object. A physical quantity of a measurement object varies depending on a work detail. Sometimes a plurality of species of physical quantities is measured relating to one work detail. A typical condition related to measurement timing is a condition such as “temperature: 5 minute interval.” In this case, sensor unit 12 measures temperature every 5 minutes. Another example of the condition may be “humidity: synchronization with capturing an image.” In accordance with this condition, sensor unit 12 measures humidity at a timing when camera 106 captures an image.

It is to be noted that conditions relating to the capturing timing and the measurement timing described above are merely examples, and various other kinds of conditions may be adopted.

The field “scheduled work period” stores data indicating a scheduled work period such as “Mar. 1, 2015-Mar. 3, 2015.” The field “Status” stores data indicating a status of work such as “Not Started,” “Working,” “Work Completed,” and so on. The field “worker name” stores data indicating a name of a worker in charge of work, such as “worker P.” A plurality of items of data is stored in field “worker name” in a case that a plurality of workers carries out one work.

FIG. 7 is a diagram illustrating a configuration of a worker table stored in memory 201. The worker table is a table for managing passwords for personal authentication of workers. The worker table includes a field “worker name” that stores data indicating worker names and a field “password” that stores passwords respectively assigned to workers.

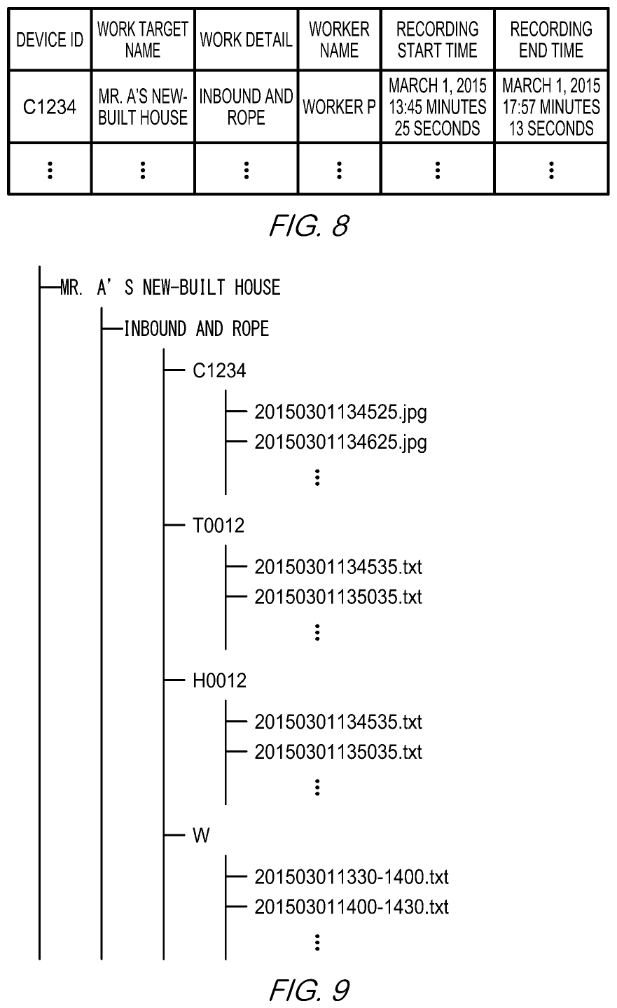

FIG. 8 is a diagram illustrating a configuration of a record management table stored in memory 201. The record management table is a table for storing data used for associating image data and measurement result data with work details to be recorded. The record management table includes fields “device ID,” “work target name,” “work detail,” “worker name,” “recording start time,” and “recording end time.”

The field “Device ID” stores a device ID for identifying camera 106 that generated image data and/or sensor unit 12 that generated measurement result data. The fields including “work target name” and “recording end time” store data indicated by names of these fields. Data stored in these fields is data received from terminal device 11 by server device 13.

Returning to FIG. 5, description of the functional configuration of server device 13 will be continued. Transmission unit 133 transmits various data to terminal device 11 and terminal device 15. Examples of data transmitted by transmission unit 133 to terminal device 11 include work detail data read by reading unit 132 from the work management table in accordance with the search condition data received by receiving unit 131 from terminal device 11, capturing timing condition data and measurement timing condition data read by reading unit 132 from the work management table based on the work identification data (data for identifying a work detail selected by a user of terminal device 11) received by receiving unit 131 from terminal device 11, and so on. Examples of data that transmission unit 133 transmits to terminal device 15 include web page data corresponding to the web page request data received by receiving unit 131 from terminal device 15, and so on.

Storage instruction unit 134 stores various data in memory 201 (an exemplary storage device.) Storage instruction unit 134 stores image data, measurement result data and work time data received from terminal device 11 by receiving unit 131 in memory 201 in association with work identification data (data for identifying a work detail to be recorded) received from terminal device 11. Further, storage instruction unit 134 stores meteorological data obtained by event obtaining unit 137 (described later) from server device 14 in memory 201 in association with work identification data (data for identifying a work detail to be recorded) received from terminal device

FIG. 9 is a diagram illustrating a storage format of image data, measurement result data, and meteorological data to be stored in memory 201 in accordance with an instruction of storage instruction unit 134. Storage instruction unit 134 causes memory 201 to create folders having a hierarchical structure of “work target name,”—“work detail,”—and “device ID/meteorological phenomenon.” In a level of “work target name,” a folder corresponding to a work target name such as “Mr. A's new-built house” is created. In a hierarchy of “work detail,” a folder corresponding to a work detail such as “inbound and rope” is created. In a level of “device ID/meteorological phenomenon,” a folder corresponding to a device ID such as “C1234,” or a folder storing meteorological data indicated by “W” is created.

The image data and the measurement result data received from terminal device 11 by server device 13 and the meteorological data obtained from server device 14 by server device 13 is sorted and stored in one of the folders created in the level of “device ID/meteorological phenomenon” based on data stored in the record management table. It is to be noted that, in the example of FIG. 9, file names of image data and measurement result data indicate time (when an image is captured or when the measurement is taken) the time at which the data was generated, and file names of meteorological data indicate a time period during which the meteorological data was measured.

It is to be noted that the above-described folder structure and naming rules for file names are mere examples, and other folder structures and naming rules may be adopted.

Returning to FIG. 5, description of the functional configuration of server device 13 will be continued. Work time obtaining unit 135 obtains work time data corresponding to the work identification data (data for identifying a work detail to be recorded) received from terminal device 11. Specifically, work time obtaining unit 135 obtains, via reading unit 132, a combination of data stored in the field “recording start time” and data stored in the field “recording end time” of a record corresponding to a work detail to be recorded in the record management table as work time data.

Work position obtaining unit 136 obtains work position data corresponding to the work identification data (data for identifying a work detail to be recorded) received from terminal device 11. Specifically, work position obtaining unit 136 reads work position data stored in the field “work position” of the work management table corresponding to the work target name to be recorded via reading unit 132.

Event obtaining unit 137 obtains meteorological data corresponding to the work time data received from terminal device 11 and the work position data obtained by work position obtaining unit 136 from server device 14. Specifically, event obtaining unit 137 transmits to server device 14 request data for requesting meteorological data including the work time data obtained by work time obtaining unit 135 and the work position data obtained by work position obtaining unit 136, and receives meteorological data transmitted from server device 14 as a response to the request data.

Work history generating unit 138 and required time generating unit 139 are units that generate data to be displayed on a web page when server device 13 receives from terminal device 15 a request for a web page for viewing images.

Work history generating unit 138 generates work record data indicating a time period and a length of a time period during which work has been performed, each of the work corresponding to plural work details relating to a work target included in an image viewed by a user of terminal device 15. Specifically, work history generating unit 138 extracts a record of a work target name specified from the record management table, and generates data indicating a time period indicated by the record start time and the record end time for each work detail and length of the time period, as the work record data.

Required time generating unit 139 generates required time data indicating a statistical amount (for example, an average value) of required time of the same or similar work detail relating to another work target for each of the plurality of work details relating to a work target of an image to be viewed by a user of terminal device 15.

Specifically, for example, when a user of terminal device 15 browses an image of “Mr. A's new-built house,” required time generating unit 139 extracts a work management table of another work target. The extracted work management table stores data similar to the data stored in the fields “work target type” and “scale” of a work management table corresponding to “Mr. A's new-built house.” Subsequently, for each of the extracted plurality of work management tables, required time generating unit 139 extracts records corresponding to the work target name from the record management table, and calculates a time length from recording start time to recording end time for each work detail. Thereby, for each work detail in “Mr. A's new-built house,” such as “carry-in/rope,” “root cutting,” and so on, a time required for another work target having the same or similar work type and scale as “Mr. A's new-built house” is calculated. Required time generating unit 139 calculates a statistical value (for example, an average value) of the required time calculated in this way for each work detail.

The foregoing is an explanation of a functional configuration of server device 13. Sensor unit 12 is a known measurement device that measures a physical quantity and outputs to terminal device 11 measurement result data indicating measurement results. Therefore, a detailed description of sensor unit 12 will be omitted. Server device 14 is a known server device that transmits meteorological data in response to a request from server device 13. Therefore, a detailed description of server device 14 will be omitted. Terminal device 15 is a known terminal device that requests a web page from server device 13 and displays a web page according to data transmitted from server device 13. Therefore, a detailed description of terminal device 15 will be omitted.

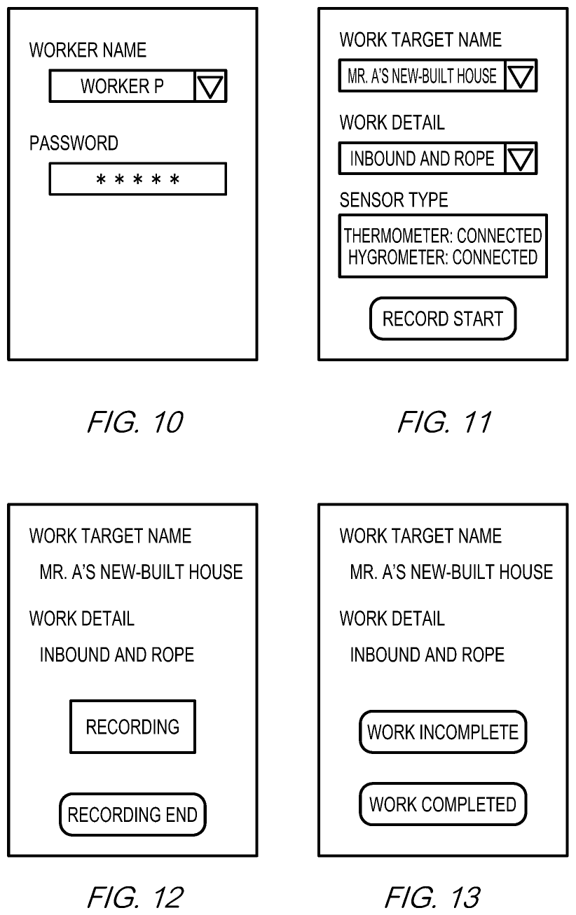

Next, operation of image recording system 1 will be described. First, a worker goes to a work area and connects sensor unit 12 to terminal device 11. Subsequently, the worker operates terminal device 11 to display a login screen shown in FIG. 10. The worker selects his/her worker name on the login screen, inputs a password assigned to him/her, and then touches an “OK” button. In response to this touch operation, terminal device 11 transmits the worker name and the password to server device 13.

Server device 13 collates the worker name and the password transmitted from terminal device 11 with reference to the worker table. If the verification is successful, server device 13 searches for records corresponding to the worker name from the work management table. In this case, data indicating the worker name transmitted from terminal device 11 to server device 13 is used in server device 13 as search condition data indicating a search condition for searching for a work detail.

Server device 13 generates web page data indicating a screen for selecting a work detail using the retrieved record and transmits the web page data to terminal device 11. The web page data transmitted from server device 13 to terminal device 11 includes work detail data indicating a work detail corresponding to a worker. Terminal device 11 displays a screen for selecting a work detail shown in FIG. 11 according to the web page data received from server device 13.

In a column “work target” on the screen for selecting a work detail, work target names of work details of which the worker is in charge are shown as a pull-down menu. When a worker selects a work target name of a work target to be recorded in the column “work target,” work details relating to the work target are displayed as the pull-down menu in the column “work detail.” When the worker selects a work detail to be recorded in the column “work detail,” types of sensor units 12 corresponding to the work detail and presence or absence of connection of these sensor units 12 are displayed in the column “sensor type.” It is to be noted that the web page data of the screen for selecting a work detail includes capturing timing condition data and measurement timing condition data corresponding to the work detail although the data is not displayed on the screen for selecting work details.

The worker selects a correct work target and a work detail on the screen for selecting a work detail, and confirms that appropriate sensor units 12 are correctly connected. Then, the worker touches “record start” button. In response to the touch operation, terminal device 11 obtains start instruction data indicating a recording start instruction.

In accordance with the obtaining of the start instruction data, terminal device 11 generates record management data and transmits the record management data to server device 13. The record management data indicates a device ID of camera 106 used for capturing an image, a device ID of sensor unit 12 used for measuring a physical quantity, a work target name, and a work detail selected by the worker, a worker's name, and record start time indicating a time when the “start recording” button is touched. The record management data includes work identification data (data indicating a work target name and a work detail) for identifying a work detail selected by a worker. Upon receiving the record management data from terminal device 11, server device 13 adds a new record to the record management table and stores the received record management data. In addition, server device 13 generates a folder corresponding to the received record management data. Further, server device 13 retrieves a record corresponding to the received record management data from the work management table, and updates a value of the column “status” of the retrieved record, to “working.”

Thereafter, terminal device 11 instructs camera 106 to capture at a timing in accordance with the capturing timing condition data (corresponding to the work detail selected by the worker) included in the web page data of the screen for selecting a work detail. Terminal device 11 obtains image data generated by camera 106 according to the instruction. Terminal device 11 attaches a file name indicating the current time to the obtained image data, and transmits the image data to server device 13 together with the device ID of camera 106. Upon receiving the image data from terminal device 11, server device 13 retrieves a record corresponding to the device ID received together with the image data from the record management table, and stores the received image data in a folder corresponding to the retrieved record data.

Furthermore, terminal device 11 instructs sensor unit 12 to measure at a timing in accordance with the measurement timing condition data (corresponding to the work detail selected by the worker) included in the web page data of the screen for selecting a work detail. In addition, terminal device 11 obtains measurement result data generated by sensor unit 12 according to the instruction. Terminal device 11 attaches a file name indicating the current time to the obtained measurement result data and transmits the measurement result data to server device 13 together with the device ID of sensor unit 12. Upon receiving the measurement result data from terminal device 11, server device 13 retrieves a record corresponding to the device ID received together with the measurement result data from the record management table, and stores the received measurement result data in a folder corresponding to the retrieved record data.

Server device 13, which has added the record management data received from terminal device 11 to the record management table, obtains meteorological data corresponding to the record management data from server device 14, for example, at predetermined time intervals. Server device 13 stores the meteorological data in a folder corresponding to the record management data.

As described above, after the “start recording” button is touched on the screen for selecting work details by the worker, the image data showing states of work, the measurement result data indicating, for example, the environmental attributes of a work area, and meteorological data indicating meteorological phenomenon of a work area, are sequentially stored in server device 13 in association with the work identification data for identifying the work detail to be recorded. Meanwhile, a recording screen shown in FIG. 12 is displayed on terminal device 11. A work target name and a work detail to be recorded are displayed on the recording screen, and a message indicating that recording is being performed is also displayed on the recording screen.

Thereafter, the worker touches a “recording end” button on the recording screen when the worker finishes his/her work. In response to the touch operation, terminal device 11 obtains end instruction data indicating a record end instruction. In accordance with obtaining the end instruction data, terminal device 11 instructs camera 106 to stop capturing an image, and instructs sensor unit 12 to stop the measurement. Subsequently, terminal device 11 generates record management data indicating a device ID of camera 106, a device ID of sensor unit 12, a work target name and a work detail to be recorded, a worker name, and recording end time indicating a time when the “recording end” button is touched. Terminal device 11 transmits the record management data to server device 13.

Upon receiving the record management data from terminal device 11, server device 13 retrieves a corresponding record from the record management table. Server device 13 stores data indicating record end time indicated by the received record management data in a column “record end time” of the retrieved record. Thereafter, server device 13 stops obtaining meteorological data corresponding to the record.

After transmitting the record management data to server device 13, terminal device 11 displays a status confirmation screen shown in FIG. 13. A work target name and a work detail that were to be recorded are displayed on the status confirmation screen, and a “work completed” button and a “work incomplete” button are also displayed on the status confirmation screen. The worker touches the “work incomplete” button if the worker has not completed the work that was to be recorded. The worker touches the “work completed” button if the worker has completed the work that was to be recorded. Terminal device 11 transmits to server device 13 completion notification data indicating the completion of the work together with the work target name and the work detail if the “work completed” button is touched. Upon receiving the completion notification data from terminal device 11, server device 13 retrieves a record corresponding to the completion notification data from the work management table, and updates the value of the field “status” of the retrieved record to “work completed.”

By performing the above-described operation of image recording system 1 with respect to various work targets and work details, server device 13 accumulates image data showing status of each of the work details together with meteorological data and measurement result data indicating environmental attributes and the like in those works.

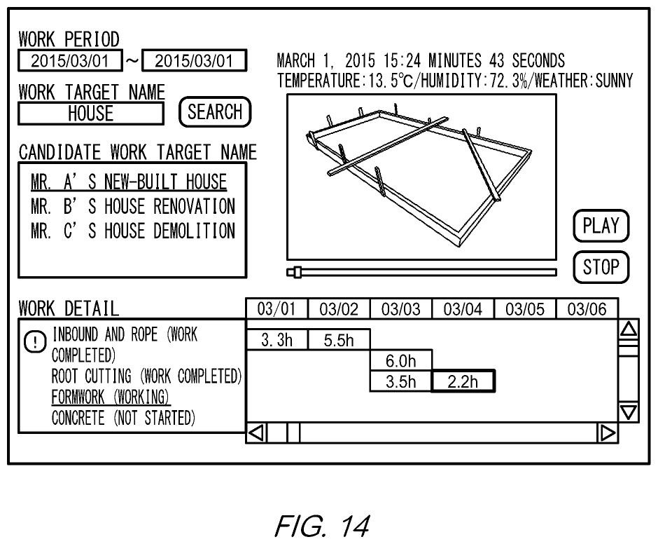

The image data accumulated in server device 13 is used, for example, when a manager of the work that is performed or the like would like to view states of works performed in the past. For example, when a user of terminal device 15 operates terminal device 15 and logs in to a web site for a manager provided by server device 13, terminal device 15 transmits to server device 13 web page request data of an image viewing screen. Server device 13 generates web page data according to the web page request data, and transmits the web page data to terminal device 15. Terminal device 15 displays an image viewing screen shown in FIG. 14 according to the web page data received from server device 13.

On the image viewing screen, the user inputs to columns “work period” and “work target name” a search condition such as beginning or end of work period and a keyword for the search, then the user operates a “search” button. In response to the operation, work target names extracted in accordance with the search condition are displayed in a list in a column “candidate work target name” of the image viewing screen. When a user selects one of the work target names from the list, work details corresponding to the selected work target name are displayed in a list in the column “work detail,” and periods and time lengths during which and for which works corresponding to those work details were performed are displayed in a timeline display column on the right side of the column “work detail.” The positive direction of the time axis is defined as the right direction in the timeline display column. A user can intuitively understand the progress of a work from the timeline display column. It is to be noted that the timeline display column is displayed based on work history data generated by work history generating unit 138.

If a user selects one of the bars corresponding to work details displayed in the timeline display column, images captured in a period corresponding to the selected bar are displayed in an image display field at the upper right of the screen, with respect to a work detail corresponding to the selected bar. If the user operates a “play” button displayed below the image display field, images displayed in the image display field are sequentially switched at predetermined time intervals in order of capturing time. In addition, if the user moves a scroll bar displayed below the image display field to the left or right, images displayed in the image display field sequentially switch in accordance with the speed and a direction of the scroll. Accordingly, the user can confirm states of work easily and quickly by viewing the images.

There is a case that a warning remind mark such as “!” is attached to the work detail displayed in the “work detail” column of the image viewing screen. If the user clicks on the warning sign, and so on, for example, a pop-up message such as “The required time of work exceeds 120% of the average value” is displayed. The message is for notifying a user that time required for a target work greatly deviates from the average time that was required for the same kind of work for the same kind of the work target. A user can easily understand from the message notified that there might be a problem with the work. In addition, regarding the work that may have a problem, a user can confirm the presence or absence of a problem and/or the cause of the problem from an image displayed in the image display field, and/or information such as temperature, humidity, weather, etc. displayed above the image display field.

As described above, according to image recording system 1, a user can record states of work with images or the like by performing simple operations. Since terminal devices with high portability such as smartphones can be used to capture and transmit images the system can be applied to work areas that are not permanently installed, such as construction sites etc., at low cost.

### <Modification>

The present invention is not limited to the embodiment described above, but may be implemented in another embodiment. For example, the present invention may be implemented in a modified embodiment described below. It is to be noted that at least two of the above embodiments and below modifications may be combined.
(1) In the embodiment described above, it is assumed that there is a plurality of work details handled by a worker who operates terminal device 11, and the worker selects a work detail to be recorded. It is not necessary for a worker to select a work detail if only one work is handled by the worker who operates terminal device 11.
(2) In the embodiment described above, a worker name of a worker who operates terminal device 11 is used as a search condition of a work detail to be recorded. A search condition searching for a work detail to be recorded is not thus limited. For example, a terminal ID may be used instead of a name of a worker as a search key of a work detail if a terminal ID of terminal device 11 (for example, a telephone number or the like if terminal device 11 is a smartphone) of a worker who is in charge of the work is stored in association with the work detail in a work management table. Further, position data measured by a position measuring device may be used as a search key if terminal device 11 includes a position measuring device such as a GPS (Global Positioning System). In this case, server device 13 retrieves, from a work management table, a record in which data indicating a work position corresponding to position data received from terminal device 11 is stored in the field “work position.” Further, server device 13 generates a screen for selecting work details by using work detail data stored in “work detail” of the retrieved record.
(3) In the embodiment described above, measurement result data and meteorological data are stored in addition to image data. Types of data to be stored in addition to image data are not thus limited. For example, sound data generated by a microphone (sound pickup device) may be stored.
(4) In the embodiment described above, image data indicate still images. Alternatively, image data may represent moving images.
(5) In the embodiment described above, there is one terminal device 11 used for recording a certain work detail. Alternatively, a plurality of terminal devices 11 may be used for recording a certain work detail. That is, image data obtained, for example, by simultaneously capturing the same work area in different capturing directions by each of cameras 106 of the plurality of terminal devices 11 may be accumulated in server device 13. In this case, a plurality of images related to the same work may be simultaneously displayed side by side in up and down or left and right positions in the image viewing screen. In that case, the plurality of images simultaneously displayed may be switched in conjunction with the capturing time.

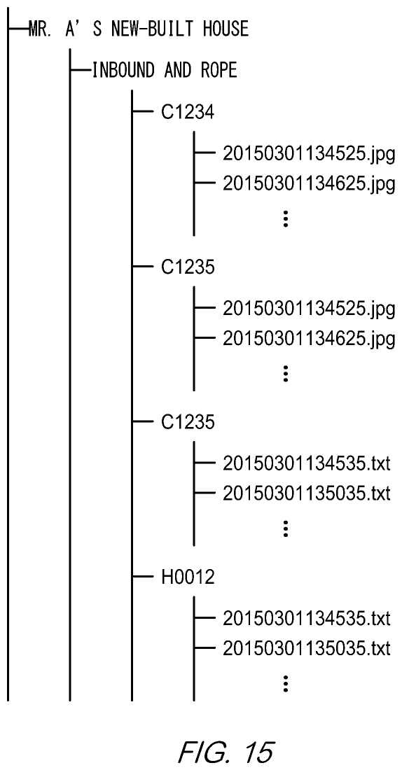

FIG. 15 is a diagram illustrating a state in which image data obtained by simultaneously capturing the same work area by each of two cameras 106 are stored in server device 13. In FIG. 15, image data representing images captured by camera 106 identified by a device ID “C1234” are stored in a folder “C1234.” Image data representing images captured by camera 106 identified by a device ID “C1235” are stored in a folder “C1235.” Both of these image data represent images of simultaneously captured states of work of a work detail “inbound and rope” of a work target, namely, “Mr. A's new-built house.”

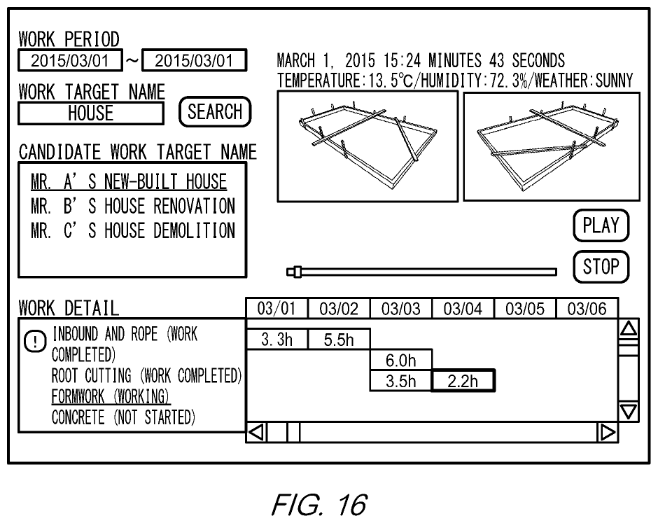

FIG. 16 is a diagram showing an image viewing screen displayed by terminal device 15 according to this modification. The image viewing screen shown in FIG. 16 includes an image display field for displaying images captured by first camera 106 and an image display field for displaying images captured by second camera 106. Images obtained by simultaneously capturing states of the same work by two different cameras 106 are respectively displayed in these image display fields. When a user moves a scroll bar displayed below these image display fields to the left or right, the images displayed in the two image display fields are interlocked and sequentially switched according to the speed and direction of scrolling. Accordingly, the user can understand the details of the states of work as the user can control the display of the images.

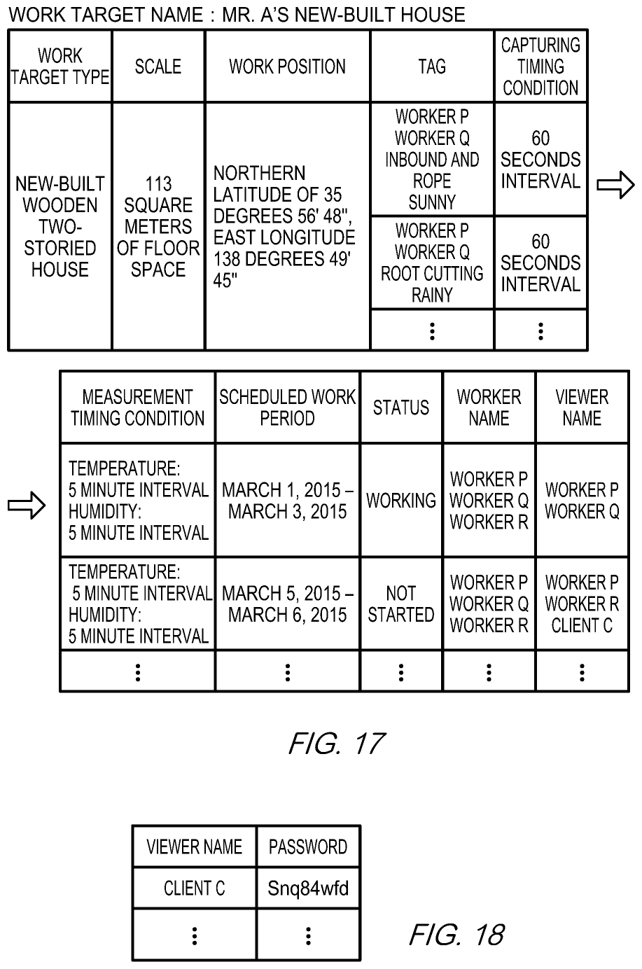

It is to be noted that, in the above explanation, it is assumed that two cameras 106 capture states of the same work simultaneously. Alternatively, three or more cameras 106 may also capture states of the same work simultaneously.
(6) In the embodiment described above, camera 106 is incorporated into terminal device 11. Alternatively, camera 106 may be configured as a device independent of terminal device 11 and connected to terminal device 11 by wired or wireless connection. In that case, a plurality of cameras 106 may be connected to terminal device 11.
(7) In the embodiment described above, start and end of recording is instructed by operations of a worker on terminal device 11. Alternatively, an instruction to terminal device 11 of at least one of start and end of a recording may be triggered by a predetermined event or the like without a worker's operation. For example, data indicating a start timing and an end timing of work corresponding to each work detail may be stored in the field “scheduled work period” of the work management table, terminal device 11 may receive the data from server device 13, recording may be started at the start timing indicated by the data, and the recording may be ended at the end timing indicated by the data. In this case, instruction obtaining unit 115 of terminal device 15 obtains start instruction data and end instruction data at a timing indicated by the data received from server device 13. Further, a start timing and an end timing of recording need not be specified directly by a worker, server device 13, or the like. For example, a configuration may be adopted in which recording is automatically terminated after a lapse of a predetermined time from a timing at which a worker has performed a recording start operation on terminal device 11. In this case, instruction obtaining unit 115 of terminal device 15 obtains start instruction data at a timing when a recording start operation is performed by a worker, and thereafter obtains end instruction data after a lapse of a predetermined time.
(8) In the embodiment described above, terminal device 11 immediately transmits image data, measurement result data, and the like to server device 13 after obtaining the data. Alternatively, terminal device 11 may store data to be transmitted to server device 13, and may transmit the stored data to server device 13, for example, each time a predetermined time elapses, at the end of the work, when terminal device 11 is connected to a network with a high communication speed, and so on.
(9) In order to prevent inconvenience caused by recording not being performed because a worker forgets to perform the operation of the “record start” button on the screen for selecting work details at the start of work, terminal device 11 may emit a sound such as a beep sound, for example, intermittently, during the recording operation. When terminal device 11 operates on battery, terminal device 11 may issue a beep sound or the like to notify a worker when a remaining charge of a battery drops so that the recording operation is not interrupted due to battery exhaustion.
(10) In the embodiment described above, data obtained by server device 13 from server device 14 and stored in association with work detail is meteorological data. Meteorological phenomenon is an example of events that affect work details, and event data indicating event of other types may be obtained and stored by server device 13. For example, traffic congestion is an event that affects transport time of raw materials and the like, and affects work progress as a result. Accordingly, a configuration may be adopted in which server device 13 receives event data indicating traffic congestion information from server device 14 that distributes traffic congestion information, and stores the event data in association with work detail affected by an event indicated by the event data. As another example of event data, for example, data indicating atmospheric pollution, floating amount of pollen and so on, earthquake, and the like can be mentioned, and it is not limited thereto.
(11) In the embodiment described above, terminal device 11 and server device 13 are realized by computers executing processing according to programs. Alternatively, one or both of terminal device 11 and server device 13 may be configured as a dedicated device including, for example, an ASIC (Application Specific Integrated Circuit) or the like.
(12) In the embodiment described above, a program for causing a computer exemplified by tablet PC 10 to execute processing of terminal device 11 and a program for causing a computer exemplified by server desktop PC 20 to execute processing of server device 13 may be distributed by being recorded on a recording medium that sustains data continuously. The programs may be distributed by being downloaded to a computer via a data communication network such as the Internet.
(13) The configuration of various data exemplified in the above embodiment may be changed. For example, the configuration of the work management table stored in server device 13 may be the configuration shown in FIG. 17. The work management table illustrated in FIG. 17 has a field “tag” and a field “viewer name,” and does not have a field “work detail” as compared with the work management table illustrated in FIG. 6.

A field “tag” is a field for storing keywords indicating attributes of work detail. A user (for example, a manager of work) can freely specify keywords to be stored in a field “tag.” Accordingly, a user can register, for example, keywords such as a name of a place where work is performed, a name of a worker, weather, a time period, and a name of work detail as a tag. In this case, the user can search images or the like of work detail desired to be viewed by these keywords in searching for a work target on the image viewing screen.
(14) A user who is permitted to view the image viewing screen may be different for each work target or for each work detail. A name of a user permitted to view the information for each work detail is stored in the field “viewer name” of the work management table shown in FIG. 17. Further, server device 13 stores a viewer table shown in FIG. 18. A viewer table is a table for managing a password for authenticating a viewer's identity. A viewer table includes, as fields, “viewer name” that stores data indicating a viewer name and “password” that stores a password assigned to a viewer.

In this modification, when a viewer accesses server device 13 by using a web browser function of terminal device and displays an image viewing screen, server device 13 asks the user of the terminal device that is accessed to input a name of the viewer and a password, and confirms that the user is a viewer registered in the viewer table. Thereafter, when the viewer browses information on the image viewing screen, server device 13 transmits to the terminal device information regarding work details in which the viewer's name is stored in the field “viewer name” of the work management table shown in FIG. 17, but does not transmit other information to the terminal device. Accordingly, the viewer can browse only information regarding work detail permitted to be viewed by the viewer on the image viewing screen.
(15) In the embodiment described above, for example, when a manager of a work browses information such as images using terminal device 15, terminal device 15 receives data such as images to be browsed from server device 13. Therefore, for example, if a size of image data is large, it takes a longer time to transmit and receive the data, and the manager may not be able to view images of the work uninterrupted. In order to solve this problem, a configuration in which terminal device 15 downloads image data and the like from server device 13 in a time period when a user is not using terminal device 15 may be adopted.

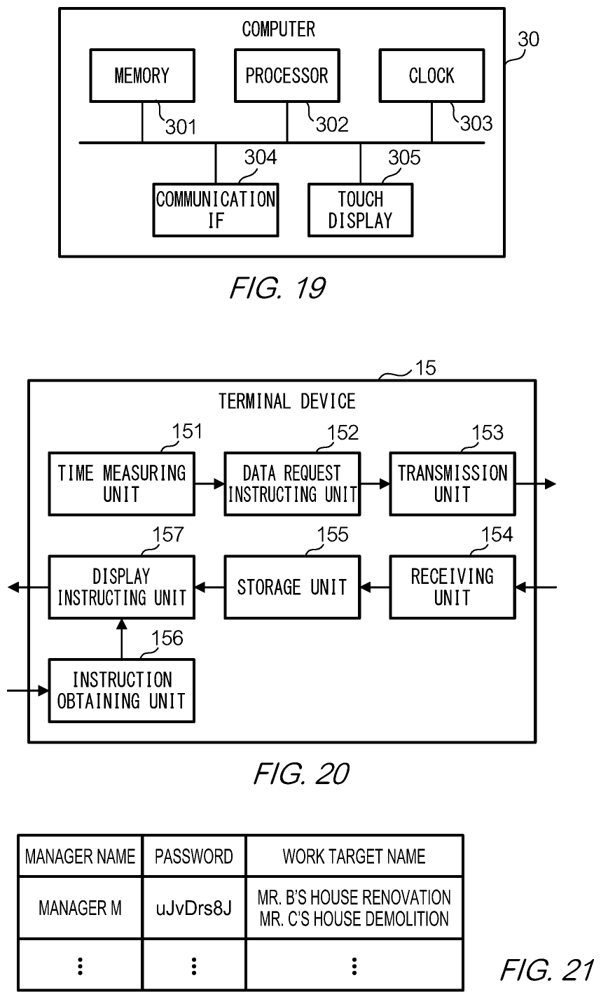

FIG. 19 is a diagram showing a basic configuration of a computer usable as hardware of a terminal device 15. The hardware configuration of terminal device 15 is the same as the hardware configuration of terminal device 11 shown in FIG. 2, except that it does not include a camera. FIG. 20 is a diagram showing a functional configuration of terminal device 15 according to this modification.

In this modification, terminal device 15 includes time measuring unit 151 for continuously measuring the current time, data request instructing unit 152 for instructing transmission unit 153 a data request to server device 13, and transmission unit 153 for transmitting a data request to server device 13.

Terminal device 15 further includes receiving unit 154 for receiving data transmitted from server device 13 in response to the data request transmitted from transmission unit 153, storage unit 155 for storing the data received by receiving unit 154, instruction obtaining unit 156 for obtaining an instruction to display an image viewing screen performed by a manager, and display instructing unit 157 for instructing touch display 305 to display the image viewing screen according to the instruction obtained by instruction obtaining unit 156.

A manager table shown in FIG. 21 is stored in server device 13. The manager table is a table for managing a password for authenticating a manager and a work target name of a download target. The manager table includes, as fields, “manager name” that stores data indicating a manager name, “password” that stores a password assigned to a manager, and “work target name” that stores a work target name indicating a target work of which a manager requires automatic download of data to terminal device 15.

Data request instructing unit 152 instructs transmission unit 153 to transmit a data request, for example, when the current time measured by clocking means 151 comes to a preset time. The data request includes a manager name and a password. Server device 13 confirms a manager name and a password included in the data request transmitted from terminal device 15 based on the data in the manager table. Thereafter, server device 13 transmits to terminal device 15 untransmitted data corresponding to the work target name registered in association with the manager name in the manager table. The data transmitted from server device 13 is stored in storage unit 155 of terminal device 15.

A manager instructs terminal device 15 to display an image viewing screen at a desired timing. In response to this instruction, display instruction unit 157 instructs touch display 305 to display an image viewing screen by using data read out from storage unit 155.

In this modification, terminal device 15 reads data from storage unit 155 and uses it without downloading data from server device 13 when display of an image viewing screen is instructed. Accordingly, display of information on an image viewing screen is performed without interruption.

It is to be noted that a timing and/or a trigger for downloading data from server device 13 by terminal device 15 may be changed. For example, data request instructing unit 152 may instruct transmission unit 153 to transmit a data request at a point in time when a predetermined time has elapsed after the last operation of terminal device 15, by a user.

### DESCRIPTION OF REFERENCE NUMERALS

1 Image recording system
7 Work area
8 Mobile phone network
9 Internet
10 Tablet PC
11 Terminal device
12 Sensor unit
13 Server device
14 Server device
15 Terminal device
20 Desktop PC for a server
101 Memory
102 Processor
103 Clock
104 Communication IF
105 Touch display
106 Camera
111 Transmission unit
112 Receiving unit
113 Display instructing unit
114 Work identification obtaining unit
115 Instruction obtaining unit
116 Image obtaining unit
117 Measurement result obtaining unit
118 Storage unit
131 Receiving unit
132 Reading unit
133 Transmission unit
134 Storage instructing unit
135 Working time obtaining unit
136 Work position obtaining unit
137 Event obtaining unit
138 Work history generating unit
139 Required time generating unit
201 Memory
202 Processor
203 Communication IF

1. A server device comprising:
a receiving unit that receives, from a terminal device, search condition data indicating a search condition for searching for a work detail;
a reading unit that reads work detail data indicating a work detail satisfying the search condition indicated by the search condition data from a storage device;
a transmission unit that transmits the work detail data to the terminal device, wherein
the receiving unit receives image data from the terminal device;
the server device further comprises a storage instruction unit that causes the storage device to store the image data in association with work identification data for identifying the work detail data;
in a case when the reading unit reads out a plurality of items of work detail data each indicating a work detail satisfying the search condition from the storage device,
the transmission unit transmits the plurality of items of work detail data to the terminal device,
the receiving unit receives, from the terminal device, work identification data identifying an item of work detail data selected by a user of the terminal device from among the plurality of items of work detail data; and
the storage instruction unit causes the storage device to store the image data in association with the work identification data received by the receiving unit.

2. The server device according to claim 1, wherein
the receiving unit receives measurement result data indicating a measurement result of a physical quantity relating to work from the terminal device, and
the storage instruction unit stores the measurement result data to the storage device in association with the work identification data.

3. The server device according to claim 1, further comprising:
a working time obtaining unit that obtains working time data indicating a working time corresponding to the work detail data,
a work position obtaining unit that obtains work position data indicating a work position corresponding to the work detail data,
an event obtaining unit that obtains event data indicating an event which affects work corresponding to the work detail data at a work position indicated by the work position data during a time period indicated by the working time data, and wherein
the storage instruction unit stores the event data to the storage device in association with the work identification data.

4. The server device according to claim 1, wherein
the receiving unit receives, from the terminal device, a plurality of items of image data, each item of image data representing a still image, and
the storage instruction unit stores the plurality of items of image data to the storage device in association with the work identification data.

5. The server device according to claim 4, wherein
the reading unit reads, from the storage device, capture timing condition data indicating a condition relating to capture timing according to the work detail data, and
the transmission unit transmits the capture timing condition data to the terminal device.

6. The server device according to claim 5, wherein
the storage instruction unit causes the storage device to create a folder corresponding to the work identification data and to store, in the folder, the plurality of items of image data received by the receiving unit.

7. The server device according to claim 1, wherein
the receiving unit receives, from the terminal device, working time data indicating a working time corresponding to the work detail data,
the storage instruction unit stores, in the storage device, the working time data in association with the work identification data,
the reading unit reads, from the storage device, working time data stored in association with work identification data for identifying work content with respect to each of a plurality of work details relating to a certain work target, and
the server device further comprises a work history generating unit that generates work history data indicating a time length or a time in which each work content corresponding to the plurality of work details relating to the certain work target is performed, based on the working time data read by the reading unit.

8. The server device according to claim 1, wherein
the receiving unit receives working time data indicating a working time corresponding to the work detail data from the terminal device,
the storage instruction unit stores the working time data in association with the work identification data in the storage device,
the reading unit reads, from the storage device, for each of the same or similar work details relating to a plurality of work objects, working time data stored in association with the work identification data that identifies a work detail relating to the same or a similar work detail, and
the server device further comprises a required time generating unit that generates required time data indicating a statistical amount of time required for work corresponding to the same or similar work details based on the working time data read by the reading unit.

9. A computer readable medium storing a program causing a computer to execute a process, the process comprising:
receiving, from a terminal device, search condition data indicating a search condition for searching for a work detail;
reading, from a storage device, work detail data indicating a work detail satisfying the search condition indicated by the search condition data;
transmitting the work detail data to the terminal device;
receiving image data from the terminal device;
causing the storage device to store the image data in association with work identification data for identifying the work detail data;
in a case when a plurality of items of work detail data are read out from the storage device, each of the plurality of items of work detail data indicating a work detail satisfying the search condition,
the plurality of items of work detail data are transmitted to the terminal device,
work identification data is received from the terminal device, the work identification data identifying an item of work detail data selected by a user of the terminal device from among the plurality of items of work detail data; and
the image data is stored to the storage device in association with the received work identification data.
